(19) United States
(12) Patent Application Publication
(10) Pub. No.: US 2010/0164699 A1
(43) Pub. Date: Jul. 1, 2010

(54) MONITORING SYSTEM FOR MONITORING AN OBJECT TO BE SECURED AGAINST UNAUTHORIZED ACCESS AS WELL AS CORRESPONDING METHOD

(75) Inventor: Prakash Mohapatra, Bangalore (IN)

Correspondence Address: NXP, B.V.;NXP INTELLECTUAL PROPERTY & LICENSING, M/S41-SJ, 1109 MCKAY DRIVE, SAN JOSE, CA, 95131, US

(73) Assignee: NXP B.V., Eindhoven (NL)

(21) Appl. No.: 12/161,119

(22) PCT Filed: Jan. 18, 2007
(86) PCT No.: PCT/IB2007/050173

§ 371 Date: Jul. 16, 2008

(30) Foreign Application Priority Data
Jan. 19, 2006 (EP) 06100609.4

(51) Int. Cl. B60R 25/10

(52) U.S. Cl. 340/426.13

(57) ABSTRACT

In order to further develop a monitoring system (100; 100) for monitoring at least one object (30) to be secured against unauthorized access as well as a corresponding method, the monitoring system (100; 100′) comprising—at least one transponder unit (40), in particular to at least one mobile phone, which transponder unit (40) can be carried with him or her by an authorized user (200), and at least one monitoring unit (10), in particular at least one monitoring chip, being designed for triggering the transmission of at least one message (m), in particular of at least one phone call or of at least one short message or of at least one multimedia message, to the transponder unit (40), in such way that the authorized user (200) is informed in case of unauthorized request of access to the object (30), in particular in case someone is trying to steal the object (30), it is proposed that the monitoring system (100; 100′) comprises at least one remote control unit (20; 20′) being designed for activating and deactivating the monitoring unit (10) by the authorized user (200), and that the transmission of the message (m) is triggered in the activated state of the monitoring unit (10) in case of request of access to the object (30).

### FIELD OF THE INVENTION

The present invention relates in general to the technical field of monitor systems and in particular to the technical field of security systems, for example to the technical field of anti-theft devices such as smart locking systems.

More specifically, the present invention relates to a monitoring system, in particular to a security system, for example to a smart locking system, as detailed in the preamble of claim 1.

Moreover, the present invention relates to a corresponding method.

### BACKGROUND OF THE INVENTION

Theft cases, in particular car theft cases, nowadays take place in an increasing number. For this reason, people are often concerned about their belongings.

One problem in this context is that if an authorized user parks a vehicle and departs from it, for example to go shopping or something else, the authorized user does not know what happens to the vehicle during his absence.

In prior art document WO 2005/059858 A1 a system for monitoring an object to be secured is described. This conventional monitoring system is implemented as a chip and bases on a conventional alarm system for providing an alert in case an unauthorized access to the object is detected. Upon sensing such an alert, the conventional monitoring system contacts a mobile phone, for which reason the contact address data are stored in the chip.

However, this conventional monitoring system is quite complex. Moreover, there is an element of insecurity, because the alarm system could be removed whereupon the entire monitoring system would fail. Thus, there is an external dependency for this conventional monitoring system to work properly.

In prior art document U.S. Pat. No. 4,996,514 a car theft proofing system with a radio transmitter for transmitting a radio wave upon insertion of an article into a cylinder lock of a car door is described. According to this car theft-proofing system the radio transmitter transmits radio signals, which are detected by a sensor of a portable remote control transmitter, whereupon the remote control transmitter transmits an abnormality alarm.

However, the remote control transmitter cannot distinguish radio signals being transmitted from different cars. This might be problematic in case there are many cars parked side by side and all of these cars are equipped with such car theft proofing system.

If one of these cars is tried to be unlocked by an unauthorized person, then the theft proofing system of the respective car generates radio signals, which are detected by all portable remote control transmitters in the vicinity.

Thus, the owner of such car theft proofing system does not know if the abnormality alarm has been triggered because his own car has been tried to be unlocked or if the alarm was triggered by a car being parked close to his own car.

Moreover, regarding the technological background of the present invention, reference can be made
to prior art document EP 0 366 378 A2,
to prior art document EP 1 369 321 A2, and
to prior art document JP 11-13 92 53.

### OBJECT AND SUMMARY OF THE INVENTION

Starting from the disadvantages and shortcomings as described above and taking the prior art as discussed into account, an object of the present invention is to further develop a monitoring system of the kind as described in the technical field, as well as a method of the kind as described in the technical field in such way that the authorized user is informed in case of unauthorized request of access to the object, in particular in case someone is trying to steal the object.

This technical problem of the present invention is solved by a monitoring system comprising the features of claim 1 as well as by a method comprising the features of claim 11. Advantageous embodiments and expedient improvements of the present invention are disclosed in the respective dependent claims.

The present invention is based on the idea of providing a monitoring system, in particular a security system, for example a smart locking system, being designed for enabling the authorized user, in particular the owner, of the monitoring system and/or of the object to be aware about what is going on with the object during the absence of the authorized user from the object.

Thus, from security viewpoint the present invention is much better than conventional monitoring systems and the number of thefts of objects, in particular of transport means, such as of vehicles, can be reduced drastically by using the present invention.

The present invention further relates to a monitoring unit, in particular to a monitoring chip, for example to an anti-theft device, for the monitoring system as described above.

Said monitoring unit is designed for triggering the transmission of the message in the activated state of the monitoring unit in case of unauthorized access to the object.

To this aim, according to a preferred embodiment of the present invention the monitoring unit is designed for detecting mechanical forces or mechanical stress being applied to the monitoring unit, in particular for detecting any disturbance of the monitoring unit, and for triggering the transmission of the message in such case of application of mechanical forces or mechanical stress, in particular in such case of any disturbance of the monitoring unit.

More particularly, according to a preferred embodiment of the present invention the monitoring unit has the capability of getting in contact with the transponder unit, in particular of sending at least one phone call, or at least one short message, or at least one multimedia message to the mobile phone (which mobile number it is not specified till now), upon any disturbance of the monitoring unit.

For detecting mechanical forces or mechanical stress being applied to the monitoring unit and for triggering the transmission of the message in such case, the monitoring unit advantageously comprises at least one piezoelectric crystal for generating electricity in case of application of mechanical forces or of mechanical stress.

However, the present invention is not restricted to the use of some sort of piezoelectric crystal in the monitoring unit; anything else that can detect motion can be used. Ideally the monitoring unit should not have any external dependency for detecting request for access, in particular for detecting motion.

Independently thereof or in connection therewith the monitoring unit optionally comprises at least one memory unit for storing at least one contact address data of the transponder unit, in particular at least one phone number of the mobile phone.

The monitoring unit is advantageously assigned to, in particular arranged at and/or comprised in, at least one access device, in particular at least one door, such as at least one door lock, and/or at least one window, of the object.

For detecting insertion into an access device lock of the object, in particular into a door lock, of a key or of another article, the monitoring unit can be arranged, in particular embedded, in the access device lock of the object.

According to a preferred embodiment of the present invention, the monitoring unit is designed for triggering the transmission of the message in the activated state of the monitoring unit even in case of regular use of the access device of the object.

For example, the monitoring unit can advantageously be implemented as one or more chips being attached in the car door lock and storing the phone number of the authorized person's mobile phone. In case of any disturbance to said chip(s), or when somebody tries to open the car door with a duplicate key or even if someone tries to open the car door with the original key without deactivating said chip(s), in active state a preferred embodiment of the monitoring unit will phone or call the phone number stored in it.

Thus, according to a preferred embodiment of the present invention alarm is given even when the object, in particular the vehicle or car, is opened with original key or duplicate key, but the monitoring unit is in activated state.

Especially in case the monitoring system is used to monitor two or more objects, the monitoring unit advantageously comprises at least one unique identification number
being transmittable to the transponder unit together with the message and/or
being storable in the transponder unit, in particular by means of at least one transponder memory unit.

Thus, according to an advantageous embodiment of the monitoring system according to the present invention each monitoring unit has the unique identification number, which will be stored in the transponder unit, in particular in the mobile phone.

The present invention further relates to a remote control unit for the monitoring system as described above, wherein the remote control unit is designed for activating and deactivating the monitoring unit.

By means of the remote control the authorized person or car owner may cancel the operable state of the monitoring unit before requesting access to the object, in particular before opening the car door. Consequently, the message will not be triggered when the authorized person requests and/or gains access to the object.

Thus, by activating and deactivating the monitoring unit, in particular by enabling and disabling the monitoring chip, false alarms can be prevented.

Said remote control unit can advantageously be assigned to, in particular arranged at and/or comprised in, the transponder unit.

Moreover, the remote control unit can optionally be designed for programming the monitoring unit with the contact address data of the transponder unit, in particular with the phone number of the mobile phone.

Furthermore, the present invention relates to a transponder unit for the monitoring system as described above, wherein the transponder unit is designed for receiving the message having been triggered in the activated state of the monitoring unit in case of request of access to the object.

In order to save costs, as transponder unit a conventional mobile phone can be used. This is advantageous because most people already have a mobile phone.

The present invention as described above comprises the advantage that its operation is quite simple and that it is very portable compared to conventional monitoring systems or security systems.

In contrast to prior art document U.S. Pat. No. 4,996,514 a preferred embodiment of the present invention neither uses nor requires an alarm signal for triggering the transmission of the message.

In activated state, request of access is rather detected by the monitoring system, in particular by the monitoring unit, itself. For example, according to a preferred embodiment the monitoring chip itself can detect the motion or disturbance as it is attached to the door if someone tries to open the door when the chip is active.

Moreover, according to a preferred embodiment of the monitoring unit of the present invention a single chip can take care of
storing the contact address data,
detecting if access to the object is required, and
triggering the transmission of the message in case of such request of access, in particular in case of mechanical forces or mechanical stress being applied to the chip, for example in case of any disturbance of the chip.

A further advantage of the present invention is that the monitoring system comes into play in active state upon request of access, for example when the thief is struggling to open the door. That gives a fair possibility to check the object from being unauthorized accessed, in particular from being stolen, or to report to the police for catching the unauthorized person.

In contrast to the present invention conventional alarm systems are activated when the access device is opened, for example when the thief opens the door, which is too late to check the crime to happen.

The present invention finally relates to the use of a method as described above and/or of at least one monitoring system as described above, in particular
of at least one monitoring unit, for example of at least one security system, such as of at least one smart locking system, as described above, which monitoring unit can be assigned to, in particular arranged at and/or comprised in, at least one access device, in particular at least one door, such as at least one door lock, and/or at least one window, of at least one object, in particular of at least one transport means, such as of at least one vehicle, to be secured against unauthorized access,
of at least one remote control unit as described above, which remote control unit can be carried with him or her by an authorized user, and
of at least one transponder unit as described above, which transponder unit can be carried with him or her by the authorized user,
   for monitoring the object to be secured against unauthorized access, in particular for monitoring at least one access device, for example at least one door, in at least one automotive or non-automotive application, for example for preventing theft of at least one vehicle.

In other words, the present invention can be used in the automotives division to provide the right kind of security to high-end cars as well as to mid-class cars as well as to cheap cars.

### BRIEF DESCRIPTION OF THE DRAWINGS

As already discussed above, there are several options to embody as well as to improve the teaching of the present invention in an advantageous manner. To this aim, reference is made to the claims respectively dependent on claim 1, on claim 2, on claim 7, and on claim 11; further improvements, features and advantages of the present invention are explained below in more detail with reference to two preferred embodiments by way of example and to the accompanying drawings where

FIG. 1 schematically shows a first embodiment of a monitoring system according to the present invention being operated according to the method of the present invention; and

FIG. 2 schematically shows a second embodiment of a monitoring system according to the present invention being operated according to the method of the present invention.

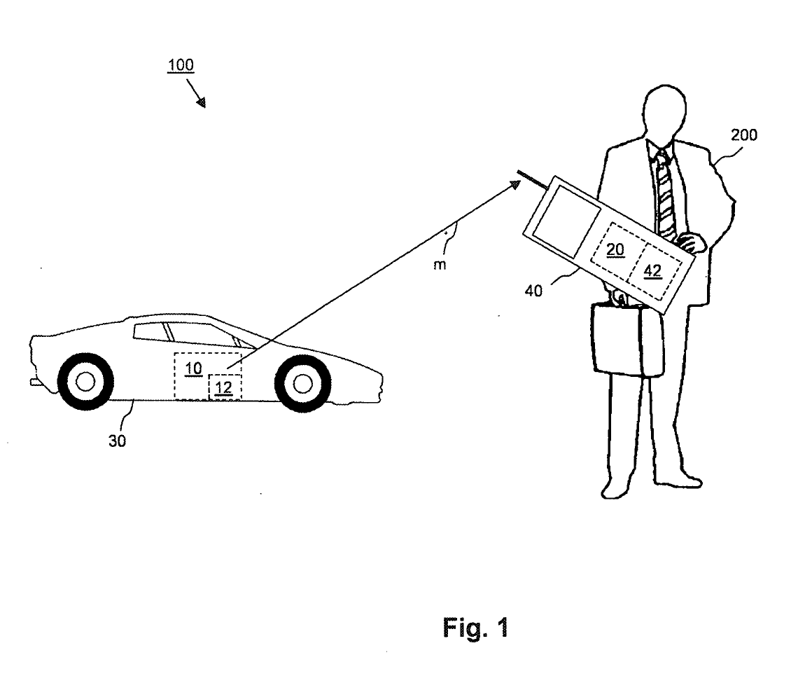

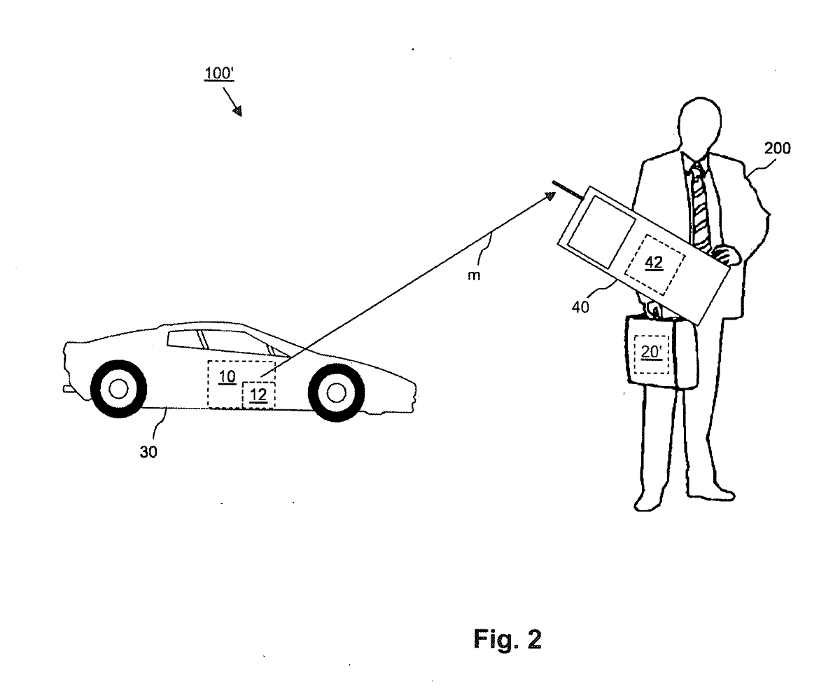

The same reference numerals are used for corresponding parts in FIG. 1 and in FIG. 2.

### DESCRIPTION OF EMBODIMENTS

In order to avoid unnecessary repetitions, the following description regarding the embodiments, characteristics and advantages of the present invention relates (unless stated otherwise)
to the first embodiment of the monitoring system 100 according to the present invention (cf. FIG. 1) as well as
to the second embodiment of the monitoring system 100′ according to the present invention (cf. FIG. 2).

FIG. 1 and FIG. 2 respectively show a monitoring system, in particular a security system, more particularly a smart locking system 100, 100′, for monitoring a car 30 to be secured against unauthorized access.

The smart locking system 100, 100′ comprises a transponder unit, namely a mobile phone 40, which can be carried with him or her by an authorized user or owner 200 of the smart locking system 100, 100′ and/or of the car 30.

Moreover, the smart locking system 100, 100′ comprises a monitoring unit, in particular a monitoring chip 10, being designed for triggering the transmission of at least one message m, in particular of at least one phone call or of at least one short message or of at least one multimedia message, to the mobile phone 40.

Said monitoring chip 10 is assigned to, in particular connected to, the inside of the door lock of the car 30. Because the monitoring chip 10 is embedded into the door lock, the monitoring chip 10 is not visible when looking at the car, and for this reason the monitoring chip 10 is depicted by dotted lines in FIG. 1 and in FIG. 2.

The smart locking system 100, 100′ further comprises a remote control unit 20, 20′ being designed for activating and deactivating the monitoring chip 10 by the owner 200. And also to program the mobile phone number of the owner in the chip 20, 20′.

Said remote control unit 20 can be comprised in the mobile phone 40 as depicted in FIG. 1. However, it is also possible that the remote control unit 20′ is an independent or self-contained unit as depicted in FIG. 2.

Because of the integration of the remote control unit 20 in the mobile phone 40 (FIG. 1) or because the remote control unit 20′ is put in the briefcase of the owner 200 (FIG. 2), the remote control unit 20, 20′ is not visible when looking at the outside of the mobile phone (FIG. 1) or of the briefcase (FIG. 2), and for this reason the remote control unit 20, 20′ is depicted in FIG. 1 and in FIG. 2 by dotted lines.

According to the smart locking system 100, 100′ the transmission of the message m is triggered in the activated state of the monitoring chip 10 in case of request of access to the car 30.

More particularly, the embodiments 100, 100′ of the present invention as depicted in FIG. 1 and in FIG. 2 use the mobile phone 40 and the monitoring chip 10, this monitoring chip 10 being embedded in the door lock of the car 30 and being able to make phone calls or to send short messages and/or multimedia messages.

This monitoring chip 10 can store a phone number by means of a memory unit 12 and in case of any disturbance to the monitoring chip 10, for example when somebody tries to open the door with a duplicate key, this monitoring chip 10 makes a call or sends a message to the phone number stored in it.

This phone number is advantageously the phone number of the mobile phone 40 of the owner 200 of the vehicle 30. Even if someone tries to open the door with the original key without deactivating the monitoring chip 10, the monitoring chip 10 will make a phone call or send a message to this mobile number.

In other words, characteristics of the monitoring chip 10 are
being attached to the door lock of the car 30,
being able to store a mobile phone number, which mobile phone number is programmable by the remote control 20, 20′,
being designed for being activated and being deactivated by the remote control 20, 20′, and
in active state, being able to make phone calls or to send messages to the number stored in it when the monitoring chip 10 is disturbed.

Moreover, preferably each monitoring chip 10 has a unique identification number, which will be stored in the mobile phone 40, in particular in a memory unit 42 of the mobile phone 40.

In this way if somebody tries to steal the vehicle 30 the monitoring chip 10 will instantly make a phone call or send a message to the owner 200 alerting him or her about the danger, and there is some chance that the owner 200 can come and save his car 30.

Moreover, also in case the owner 200 had lost keys after activating the monitoring chip 10, then he or she can also be alerted if somebody is trying to open the door with the original keys.

So whenever the owner 200 parks his vehicle 30, when and/or after locking the door, the owner 200 activates the monitoring chip 10 by means of the remote control unit 20, 20′ before going away or before leaving the car 30.

Thereupon a thief can have the original keys or the duplicate keys for the car 30; in any case if the thief tries to break into the car 30 the activated monitoring chip 10 intimates the owner 200 that there is an attempted break-in to the car 30 by making a call or sending a message to his mobile phone 40.

Thus, the owner receives the alert call regarding the attempted theft of his car 30. After knowing about the attempted break-in the owner 200 can inform the police or reach his or her car immediately to prevent the thief from stealing the car 30.

On the other hand, for preventing false alarms, before opening the door the monitoring chip 10 is deactivated by the owner 200. Such deactivation can be performed by disabling or canceling the operable state of the monitoring unit 10 by the authorized user 200, especially before or when unlocking the door lock of the car 30.

1. A monitoring system for monitoring at least one object to be secured against unauthorized access, the monitoring system comprising
at least one transponder unit, in particular to at least one mobile phone, which transponder unit can be carried with him or her by an authorized user, and
at least one monitoring unit, in particular at least one monitoring chip, being designed for triggering the transmission of at least one message, in particular of at least one phone call or of at least one short message or of at least one multimedia message, to the transponder unit,
wherein the monitoring system comprises at least one remote control unit being designed for activating and deactivating the monitoring unit by the authorized user, and
that the transmission of the message is triggered in the activated state of the monitoring unit in case of request of access to the object.

2. A monitoring unit for the monitoring system according to claim 1,
wherein being designed for triggering the transmission of the message in the activated state of the monitoring unit in case of request of access to the object.

3. The monitoring unit according to claim 2, characterized by being designed
for detecting mechanical forces or mechanical stress being applied to the monitoring unit and
for triggering the transmission of the message in such case of application of mechanical forces or of mechanical stress.

4. The monitoring unit according to claim 1, characterized by being assigned to, in particular arranged at and/or comprised in, at least one access device, in particular at least one door, such as at least one door lock, and/or at least one window, of the object, in particular of a transport means, such as of a vehicle.

5. The monitoring unit according to claim 1, characterized by at least one piezoelectric crystal generating electricity in case of application of mechanical forces or mechanical stress.

6. The monitoring unit according to claim 1, characterized by
at least one memory unit for storing at least one contact address data of the transponder unit, in particular at least one phone number of the mobile phone, and/or
at least one unique identification number
being transmittable to the transponder unit together with the message and/or
being storable in the transponder unit, in particular in at least one memory unit of the transponder.

7. A remote control unit for the monitoring system according to claim 1,
wherein being designed for activating and deactivating the monitoring unit.

8. The remote control unit according to claim 7, characterized in that
activating the monitoring unit is performed by enabling and/or starting the operable state of the monitoring unit, in particular by the authorized user, for example during or after locking the access device of the object, and
deactivating the monitoring unit is performed by disabling and/or canceling the operable state of the monitoring unit, in particular by the authorized user, for example before or during requesting access to the object, such as before or during unlocking the access device of the object.

9. The remote control unit according to claim 1, characterized by
being assigned to, in particular arranged at and/or comprised in, the transponder unit and/or
being designed for programming the monitoring unit with at least one contact address data of the transponder unit, in particular with at least one phone number of the mobile phone.

10. A transponder unit for the monitoring system according to claim 1,
wherein being designed for receiving the message having been triggered in the activated state of the monitoring unit in case of request of access to the object.

11. A method for monitoring at least one object to be secured against unauthorized access, the method comprising the steps of
activating at least one monitoring unit, in particular at least one monitoring chip,
monitoring if access to the object is requested and
triggering the transmission of at least one message, in particular of at least one phone call or of at least one short message or of at least one multimedia message, to at least one transponder unit, in particular to at least one mobile phone, if access to the object is requested.

12. The method according to claim 11, characterized in that the step of monitoring if access to the object is requested comprises detecting if mechanical forces or mechanical stress are applied to the monitoring unit.

13. Use of a method according to claim 11 and/or of at least one monitoring system according to claim 1, in particular
of at least one monitoring unit, for example of at least one security system, such as of at least one smart locking system, according to claim 1, which monitoring unit can be assigned to, in particular arranged at and/or comprised in, at least one access device, in particular at least one door, such as at least one door lock, and/or at least one window, of at least one object, in particular of at least one transport means, such as of at least one vehicle, to be secured against unauthorized access,
of at least one remote control unit according according to claim 1, which remote control unit can be carried with him or her by an authorized user, and
of at least one transponder unit according to claim 10, which transponder unit can be carried with him or her by the authorized user,
for monitoring the object to be secured against unauthorized access, in particular for monitoring at least one access device, for example at least one door, in at least one automotive or non-automotive application, for example for preventing theft of at least one vehicle.
